(19) United States
(12) Patent Application Publication
(10) Pub. No.: US 2026/0278743 A1
(43) Pub. Date: Sep. 17, 2026

(54) PARALLAX ENGINE FOR AUTO-FRAMING OVER REPLACED BACKGROUNDS

(71) Applicant: Intel Products IP LLC, Santa Clara, CA (US)

(72) Inventors: Rony Zatzarinni, Tel Aviv (IL); Chaim Gross, Jerusalem (IL); Dor Barber, Herzliya (IL); Mor Hadar, Kiryt Ono (IL); Hava Matichin, Petah Tikva (IL)

(73) Assignee: Intel Products IP LLC, Santa Clara, CA (US)

(21) Appl. No.: 19/675,866

(22) Filed: May 13, 2026

(51) Int. Cl. G06T 5/50; G06T 3/40; G06T 7/194

(52) U.S. Cl. CPC G06T 5/50; G06T 3/40; G06T 7/194; G06T 2207/20221

(57) ABSTRACT

Systems and methods are provided for auto-framing over replaced backgrounds. An auto-framing operation and a background replacement operation are performed using a parallax engine such that a foreground subject remains stably framed while a replacement background is transformed in a controlled, depth-consistent manner. A foreground crop is determined to maintain subject centering and apparent subject scale in an output frame, while a distinct background crop is determined independently from the foreground crop. A tunable depth parameter can determine how strongly background translation and background scaling are attenuated relative to the foreground transformation. The transformed foreground and transformed background are composited using a segmentation mask to generate an output video stream exhibiting parallax-consistent background motion and reduced focal-length compression discontinuities. The system avoids flat locked coupling and pasted infinity depth artifacts. Implementations may be integrated with an image signal processor pipeline to reduce latency, bandwidth, and power.

### TECHNICAL FIELD

This disclosure relates generally to image processing, and in particular to auto-framing replaced backgrounds.

### BACKGROUND

Video conferencing applications and related imaging applications often include virtual background replacement, in which semantic segmentation produces a mask used to composite the foreground subject over a synthetic background image or texture. Additionally, video conferencing and related imaging applications generally include auto-framing, in which a detection engine identifies the subject and drives a digital pan-tilt-zoom operation by dynamically selecting a region of interest (ROI) that is cropped and scaled to a fixed output resolution. When these two features are combined, the resulting image is visually implausible. For example, when the crop window shifts to keep the subject centered, the background may translate and scale at the same rate as the foreground, yielding a flat, zero-depth look. In other examples, the background may remain effectively static relative to the moving subject, yielding an infinite-depth look that appears pasted and disconnected.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawing.

FIG. 1 is a diagram illustrating examples of auto-framing over replaced backgrounds, in accordance with various embodiments.

FIG. 2 is a block diagram of a system that can be used for auto-framing over replaced backgrounds, in accordance with various embodiments.

FIG. 3 illustrates an example parallax interpolation model, in accordance with various embodiments.

FIG. 4 illustrates a parallax framing system, in accordance with various embodiments.

FIG. 5A depicts an example static-scene enhancement in which background zoom variation is applied while the framed subject is maintained in a substantially stable pose and size.

FIG. 5B depicts an example coordinated multi-layer scaling mode in which both foreground and background layers are varied, potentially in complementary directions, to generate a stronger cinematic impression.

FIG. 6A is a flowchart showing the method for auto-framing over replaced backgrounds.

FIG. 6B is a flowchart illustrating a method for auto-framing over replaced backgrounds.

FIG. 7 is a block diagram of an example DNN system, in accordance with various embodiments.

FIG. 8 is a block diagram of an example computing device, in accordance with various embodiments.

### DETAILED DESCRIPTION

### Overview

Systems and methods are provided herein for a parallax engine for auto-framing over replaced backgrounds. The techniques include an auto-framing operation and a background replacement operation that are cooperatively performed such that a foreground subject remains stably framed while a replacement background is transformed in a controlled, depth-consistent manner. In particular, the replacement background is transformed to synthesize optical-like parallax and focal-length compression cues that improve perceived realism in a composited output video stream.

In modern video conferencing and related imaging applications, auto-framing and virtual background replacement have become widely used features. Auto-framing typically relies on a digital pan-tilt-zoom (PTZ) mechanism driven by a detection engine to identify a subject and define a dynamic region of interest (ROI) that is cropped and scaled to a fixed output resolution. Background replacement typically relies on semantic segmentation to generate a mask that separates a foreground user from a background, such that the background can be substituted with a synthetic image or texture.

A core difficulty arises when these two features are integrated using conventional planar (2D) spatial coupling, because many implementations apply a single unified transformation to the full composited frame such that the foreground and the replacement background translate and scale together. In such architectures, lateral subject motion can produce a one-to-one translational behavior, in which the background is shifted by the same pixel offset as the foreground crop window, mathematically placing the virtual background at the same apparent depth as the user and yielding a flat world (zero-parallax) appearance that lacks natural depth cues.

Some imaging systems attempt to reduce compute by cropping/framing within an image signal processor (ISP) prior to background replacement. However, cropping within the ISP can lead to a different artifact in which the replacement background is applied after the crop without access to full-frame camera coordinates. Applying background replacement after the crop causes the background to remain effectively static relative to subject motion, resulting in an infinity-depth appearance that can look pasted or disconnected. In addition, software-based or post-ISP solutions that perform segmentation, cropping, scaling, and blending on general-purpose compute resources can impose substantial latency, bandwidth, and power costs, particularly when operating on high-resolution buffers at real-time frame rates.

Systems and methods are provided herein for an architecture in which spatial transformation of the replacement background is decoupled from spatial transformation of the foreground subject, rather than locking both layers to a single crop-and-scale transform. In various implementations, the techniques are realized within (or tightly coupled to) an ISP pipeline and leverage an existing low-power processing path for efficient analysis. In some examples, the systems and methods provide functionality in a background replacement block that allows the background replacement block to perform background-specific spatial manipulation in real time.

In some implementations, a downscaled image generated by the low-power processing path of the ISP is provided to various analysis blocks. The analysis blocks include a background segmentation block that produces a segmentation map (i.e., a mask), and a user-framing block that detects the subject and determines a target foreground crop rectangle (i.e., a foreground crop). The system determines and applies two independent crop rectangles-one for the foreground and one for the background. The foreground crop preserves subject centering and scale in the output, and the background crop is computed to emulate depth-dependent motion and zoom behavior.

According to various implementations, a tunable depth parameter (spanning a range from 0 to 1) governs how strongly the background transformation is attenuated relative to the foreground transformation. For panning parallax, the background crop center may be determined by interpolating between the foreground crop center and an image-center reference as a function of the tunable depth parameter (with the tunable depth parameter equal to zero corresponding to background motion locked one-to-one with the foreground, and the tunable depth parameter equal to one corresponding to no background motion). Thus, the background translates more slowly than the subject during auto-framing events.

For zoom compression, the background crop scale may likewise be interpolated between a foreground zoom level and a full wide-view reference as a function of the tunable depth parameter, such that the background zooms in less than the foreground during digital PTZ zoom operations. In this manner, the system synthesizes cues analogous to physical optics without explicit 3D reconstruction of scene geometry. For example, distant scenery exhibits reduced apparent motion and magnification relative to a nearer subject.

In some implementations, the independently cropped and scaled foreground and background layers are composited using the segmentation map. In some examples, the foreground and background layers are composited by blending the foreground and background according to the mask to generate an output frame in which the subject remains properly framed while the background exhibits depth-consistent parallax behavior. The ISP-centric (i.e., ISP-integrated) technique provided herein can be particularly advantageous in real-time video pipelines because the technique reduces reliance on expensive post-processing and can lower latency, memory bandwidth, and power consumption while preserving a visually coherent and more natural-looking composited output.

In various implementations, the systems and methods provided herein include extended operational modes and application variants that similarly include decoupling the foreground scaling and processing and the background scaling and processing. In some examples, gradual background zoom variation can be introduced over time in relatively static scenes to add subtle visual dynamics. In some examples, the parallax-driven background behavior can be applied to a captured real scene background plate (e.g., accumulated within an ISP pipeline using temporal processing) to simulate the effect of a physical camera operator tracking a presenter rather than a digitally cropped static camera feed. Additionally, while particular examples include ISP-level or hardware-accelerated implementations (including modifications within a background replacement block), the systems and methods can be implemented using any selected hardware and/or may be implemented in software-only or hybrid hardware/software deployments. In some examples, the systems and methods provided herein can include any system that determines a depth-attenuated background crop independently from a foreground crop and composites the resulting layers to achieve adaptive parallax in the output.

For purposes of explanation, specific numbers, materials, and configurations are set forth in order to provide a thorough understanding of the illustrative implementations. However, it will be apparent to one skilled in the art that the present disclosure may be practiced without the specific details or that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device or system. Also, the term “or” refers to an inclusive “or” and not to an exclusive “or”.

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Auto-Framing Over Replaced Backgrounds

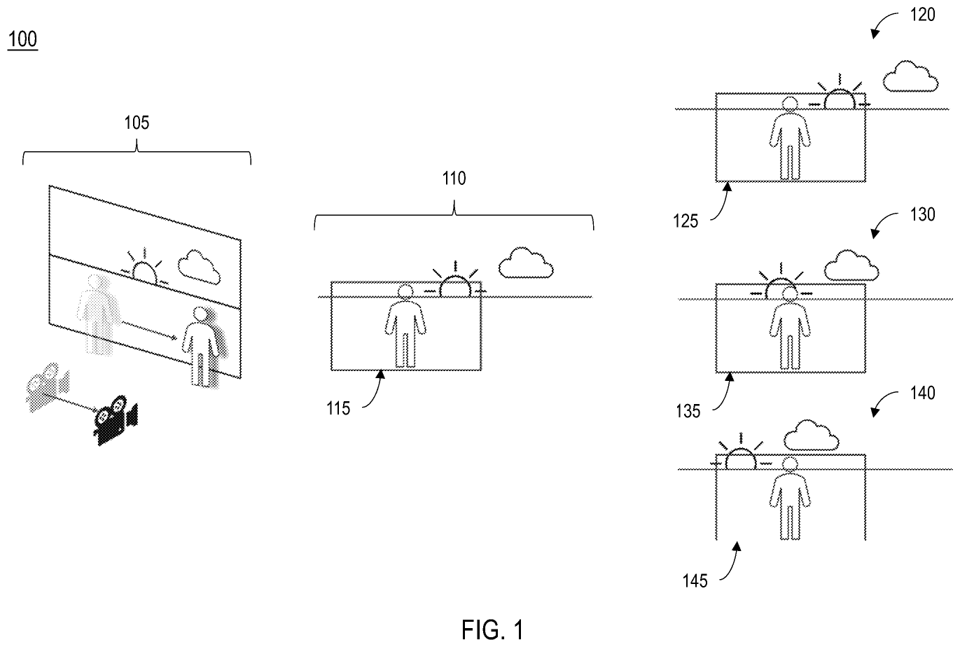

FIG. 1 is a diagram 100 illustrating examples of auto-framing over replaced backgrounds, in accordance with various embodiments. In particular, in FIG. 1, a comparative illustration is provided for a parallax framing system that operates in connection with auto-framing and background replacement, and that produces output video in which a foreground subject remains framed while a background (e.g., a replacement background) exhibits motion consistent with depth cues rather than appearing unnaturally flat or disconnected.

A first scene 105 illustrates scene dynamics, depicting an example movement event in which a subject translates laterally across a field of view while an auto-framing function tracks the subject. As illustrated, the framing behavior can be understood as a digital pan operation in which a crop window is shifted to maintain the subject within a desired portion of the output. In this context, the depicted camera icons and the subject's multiple positions convey that the input scene is changing over time and that the framing logic responds by adapting the crop location. The subject represents the foreground of the first scene 105.

An initial scene state 110 represents a reference framing condition prior to the movement event, in which a crop region 115 is selected to frame the subject. In some examples, the crop region 115 corresponds to a region of interest determined by subject detection and user-framing logic, after which the cropped region is scaled to a target output resolution for presentation (e.g., to maintain a consistent output size while the crop location changes). In some examples, the crop region 115 is updated over time as the subject moves, thereby causing a pan/tilt/zoom-like effect from a physically static camera.

A first output mode 120 is illustrated as an output frame 125 corresponding to an infinity depth behavior in which a background appears substantially static relative to framing changes of the foreground. The foreground framing changes can be based on the subject and subject movement. In some examples, an infinity depth behavior can occur when a background is applied without being cropped in coordination with the foreground framing coordinates, such that the background does not substantially translate with the subject as the crop window pans. In some examples, when the background does not substantially translate with the subject as the crop window pans, a visually pasted or disconnected appearance can result, because the foreground movement lacks corresponding depth-consistent background motion.

A second output mode 130 is illustrated as an output frame 135 corresponding to an adaptive parallax behavior in which the background translates in the same general direction as the foreground framing, but at a reduced apparent rate, thereby conveying a mid-depth impression rather than a zero-depth or infinity-depth appearance. In some examples, the effect is achieved by decoupling the spatial transformation applied to the background from the spatial transformation applied to the foreground, such that a background crop (and/or background scaling) is determined independently from the foreground crop. In some examples, the background crop used to generate the output frame 135 is larger and translates more slowly than the foreground crop, thereby restoring depth cues associated with optical parallax.

A third output mode 140 is illustrated as an output frame 145 corresponding to a zero-depth or locked-coupling behavior in which the background is cropped and translated in a one-to-one relationship with the foreground crop. In some examples, locked coupling can occur when background replacement is performed on a full frame and the auto-framing crop is subsequently applied to the composited image, resulting in identical panning and scaling applied to both foreground and background layers. In some examples, when identical panning and scaling are applied to both layers, a flat appearance is produced, which can be visually implausible and may be perceived as overly dynamic or distracting because the background motion lacks the attenuation expected for a distant scene.

In some examples, the adaptive parallax behavior illustrated by output mode 130 is governed by a tunable depth parameter that controls the degree to which background translation and/or background scaling is attenuated relative to foreground framing. For example, when the subject moves laterally and the foreground crop center shifts to maintain framing, the background crop center may be shifted by a smaller amount than the foreground crop center, thereby causing the background to appear to lag behind and creating a depth effect that is visually between the infinity-depth mode 120 and the zero-depth mode 140. In some examples, the depth parameter is selected (e.g., tuned) to achieve a visually pleasing compromise between the infinity-depth and the zero-depth endpoints.

In some examples, FIG. 1 is representative of a parallax framing technique that can be implemented efficiently within a real-time imaging pipeline by leveraging existing framing and segmentation functions while adding background-specific spatial manipulation. For instance, segmentation may provide a mask used for compositing, while the parallax engine determines a background crop distinct from the foreground crop so that the background can be cropped and scaled differently before blending into the output. In some examples, implementing at least portions of the parallax operation within an ISP-associated pipeline can reduce bandwidth, latency, and power relative to purely post-processing approaches, while still enabling adaptive background motion. In contrast, when framing is performed before background replacement without preserving framing coordinates, the infinity-depth behavior can result.

Accordingly, FIG. 1 conveys that the parallax framing system can provide an output in which auto-framing maintains subject-centric composition while background behavior is controlled to avoid the extremes of a fully static background (output mode 120/output frame 125) and a fully locked background (output mode 140/output frame 145). In some examples, the adaptive parallax mode (output mode 130/output frame 135) results in increased realism by synthesizing a depth-consistent relationship between foreground framing and background motion, thereby reducing the flat world effect and reducing the visually disconnected appearance associated with static background behavior.

### Example System for Auto-Framing Over Replaced Backgrounds

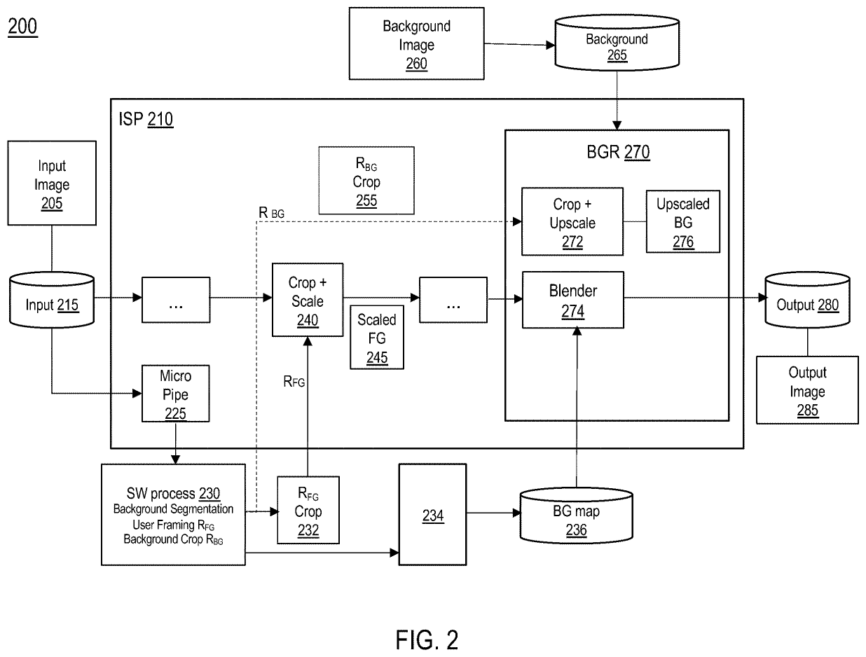

FIG. 2 is a block diagram of a system 200 that can be used for auto-framing over replaced backgrounds, in accordance with various embodiments. In some examples, the system 200 can be a parallax framing system, and, in some examples, the system 200 can be a parallax engine for auto-framing over replaced backgrounds. A parallax engine can be a component that creates a parallax effect, and can include logic that decouples the spatial transformation of the replacement background from the spatial transformation used to auto-frame the foreground subject. In various examples, a parallax engine can be implemented in hardware, software, and/or a combination of hardware and software. According to various implementations, the system 200 generates a composited output in which a foreground subject is auto-framed while a background (e.g., a replacement background) is transformed using a separate, depth-controlled transformation so that background motion is attenuated relative to foreground motion.

In some implementations, an input image 205 is provided to an input store 215 (labeled “input 215”), which may buffer one or more frames of a captured video stream for processing. The input store 215 supplies image data to an image signal processor (ISP) 210, which includes a set of processing blocks (represented by “ . . . ” blocks) that can perform one or more image processing operations prior to generation of the output image 285.

The ISP 210 includes a micro pipe 225 that receives image data from the input store 215 and generates a reduced-resolution representation of the scene that can be used for analysis at lower power and bandwidth than full-resolution processing. In some examples, the micro pipe 225 outputs a low-resolution, reduced-quality image that is used to drive analysis operations without full-resolution processing for every pixel in the frame.

A software process 230 receives the low-resolution output from the micro pipe 225 and performs background segmentation and user framing operations. In some examples, the software process 230 determines a foreground crop R_{FG} 232 that defines a region of interest for framing the subject. In some examples, the software process 230 also determines a background crop R_{BG} crop 255 that is distinct from the foreground crop.

In some examples, the background crop R_{BG} is determined using a tunable depth parameter f that controls how strongly background translation and/or background scaling is attenuated relative to the foreground crop. For example, a background crop center may be determined by interpolating between a foreground crop center and a reference center (e.g., an image center) as a function of f. A background scale may be determined by interpolating between a foreground scale and a reference scale (e.g., a full wide-view scale) as a function of f, such that 0<f<1 yields background motion and zoom that is reduced relative to the foreground.

Along a foreground path within the ISP 210, a crop-and-scale block 240 receives the foreground crop definition R_{FG} (i.e., the R_{FG} crop 232) and applies cropping and scaling to image content to produce a scaled foreground 245. In some examples, the crop-and-scale block 240 performs a digital pan/tilt/zoom operation by updating crop location and/or crop scale over time while maintaining a target output resolution for the foreground subject.

A background image 260 is provided to a background store, which supplies background content to a background replacement block 270. In some examples, the background image 260 is a synthetic image or texture selected by a user or application and stored in the background store 265 for repeated use across frames.

The background replacement block 270 receives the background crop definition R_{BG} (i.e., the R_{BG} crop 255) and applies background-specific spatial processing that is decoupled from the foreground crop-and-scale block 240 operation. In various examples, the background replacement block 270 includes a crop-and-upscale block 272 that crops background content according to R_{BG} and upscales the cropped background to generate an upscaled background 276. In some examples, the crop-and-upscale block 272 is configured to crop a different portion of the background (and/or to use a different crop size) than the portion used for the foreground, thereby enabling background motion that is slower or otherwise reduced relative to the foreground.

To support compositing, the software process 230 provides foreground and/or segmentation outputs into a segmentation map 234, which generates a background map 236. In some examples, the background map 236 is a segmentation map that indicates, per pixel, whether output content should be taken from background versus foreground, and the background map 236 may be a soft mask (e.g., having values between 0 and 1) suitable for alpha blending at object boundaries.

A blender 274 within the background replacement block 270 receives the scaled foreground 245 and the upscaled background 276, and blends the scaled foreground 245 and the upscaled background 276 using the background map 236 to produce a composited output. In some examples, the blending to generate the composite output can be expressed as:

$$Out = BG \cdot {M}_{BG} + FG \cdot ( 1 - {M}_{BG} )$$

where M_{BG} is provided by the background map 236, FG is provided by the scaled foreground 245, and BG is provided by the upscaled background 276. The blender 274 thereby generates an output in which the subject remains framed while the background exhibits depth-consistent parallax behavior.

The composited output generated by the background replacement block 270 is stored in an output store 280 and provided as an output image 285. In some examples, the output image 285 is a video frame stream suitable for real-time communication applications, where the disclosed architecture reduces reliance on heavy post-processing by performing cropping, upscaling, and blending operations in or in coordination with the ISP 210.

In some examples, the architecture of FIG. 2 is used to avoid limitations of purely post-processing approaches when framing is performed inside the ISP 210. For example, when the foreground is cropped within the ISP 210 prior to post-processing, later software stages may lack the full-frame coordinates needed to generate a depth-consistent background transformation. By supplying the background replacement block 270 with the mask and crop information and enabling background-specific manipulation (e.g., via crop-and-upscale block 272), the system 200 can generate parallax behavior efficiently while reducing bandwidth, latency, and power relative to performing the full operation outside the ISP 210.

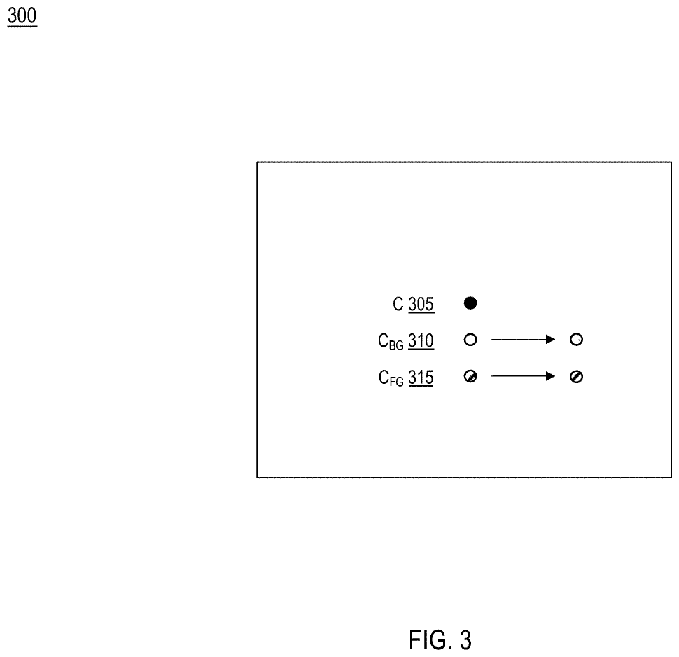

FIG. 3 illustrates an example parallax interpolation model 300, in accordance with various embodiments. In the parallax interpolation model 300, a background crop center is determined as a depth-controlled function of a foreground crop center. In the illustrated frame, a reference center C 305 is shown as a fixed point (e.g., a center of an image plane or full-frame coordinate system), a background crop center C_{BG} 310 is shown as a point that changes over time, and a foreground crop center C_{FG} 315 is shown as a point that tracks motion of a foreground subject. The arrows adjacent to the background crop center C_{BG} 310 and the foreground crop center C_{FG} 315 indicate an example lateral movement direction, in which the foreground crop center C_{FG} 315 shifts by a larger amount while the background crop center C_{BG} 310 shifts by a smaller amount, thereby producing a reduced apparent background motion relative to foreground framing.

In some examples, the foreground crop center C_{FG} 315 is provided by a user-framing process that detects a subject and determines a region of interest for auto-framing, and the reference center C 305 is a reference location selected to represent a neutral background position (e.g., an image center). In some examples, the background crop center C_{BG} 310 is determined by interpolating between the foreground crop center C_{FG} 315 and the reference center C 305 using a tunable depth parameter f such that:

$${C}_{BG} = {C}_{FG} \cdot ( 1 - f ) + C \cdot f$$

With this formulation, when f=0, C_{BG}=C_{FG} and the background motion is coupled one-to-one to the foreground. In contrast, when f=1, C_{BG}=C and the background motion is substantially fixed at the reference center. For other depth parameter values (0<f<1), the background translation is attenuated relative to the foreground, which can be perceived as a depth effect.

In some examples, the depth parameter f is selected to achieve a visually pleasing parallax balance between the coupled and fixed endpoints, and may be set to an intermediate value (e.g., f=0.5) so that the background crop center C_{BG} 310 follows the foreground crop center C_{FG} 315 with reduced magnitude while remaining biased toward the reference center C 305. In some examples, the background crop center C_{BG} 310 is output to downstream crop-definition logic as the background crop center used to select a background region of interest for cropping and/or upscaling, thereby enabling a composited output in which the foreground remains centered by the foreground crop while the background appears to move more slowly, consistent with parallax cues.

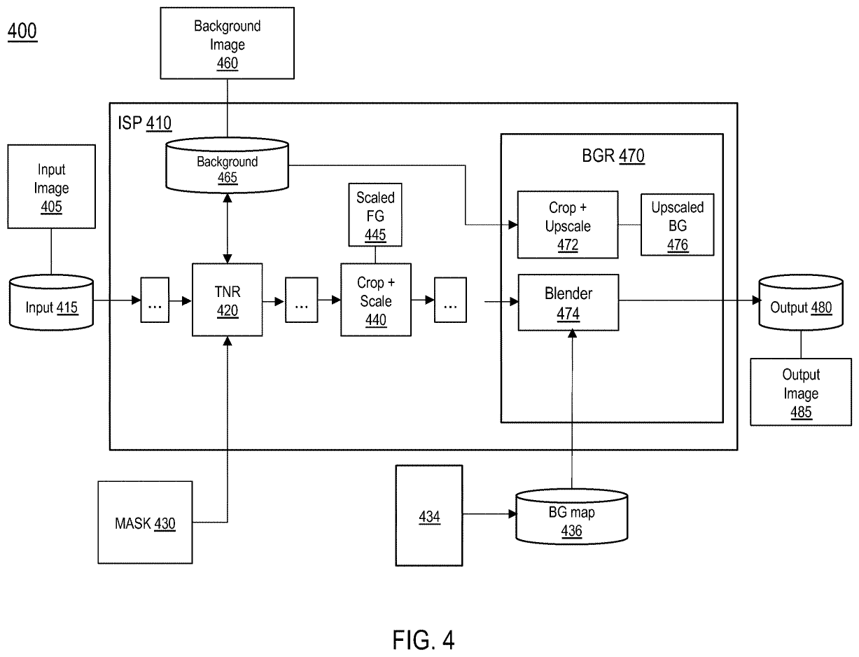

FIG. 4 illustrates a parallax framing system 400, in accordance with various embodiments. In particular, in the parallax framing system 400, an image signal processor (ISP) 410 generates a composited output image 485 from an input image 405. The ISP 410 also uses a temporal accumulation path to obtain or maintain a background that can be transformed with depth-consistent motion. The input image 405 may be buffered in an input store 415 and provided to the ISP 410 for processing through one or more intermediate pipeline stages. In operation, the system 400 generates an image in which a foreground subject is framed (e.g., via digital crop-and-scale) while a background is generated and transformed in a manner that yields a more natural visual experience than applying a single unified transformation to a fully composited frame.

In various implementations, the ISP 410 includes a temporal noise reduction (TNR) block 420. In some examples, the TNR block 420 output can be used to generate a background stored in a background store 465. In some examples, the TNR block 420 operates as a recursive temporal accumulator that blends current-frame information with a stored reference in memory, such that background pixels can be incrementally refined over time. A mask 430 can be provided to the TNR block 420 and can be used to determine how the accumulator is updated. In some examples, the mask 430 identifies foreground versus background regions so that the TNR block 420 preferentially updates the stored background in regions identified as background while suppressing updates in regions identified as foreground, thereby enabling construction of a clean background that may include content initially occluded by the subject.

A background image 460 may be provided to the background store 465 to initialize, supplement, or replace the background content used by the system 400. In some examples, the background image 460 is a captured real-scene background plate derived from the same physical environment as the input image 405, and the background store 465 maintains the background plate for use by downstream compositing operations. In various examples, using a real-scene background plate enables the system 400 to generate a background that is not merely a synthetic replacement, and can instead represent the user's actual environment with reduced foreground interference.

Along a foreground processing path within the ISP 410, a crop-and-scale block 440 receives image content (e.g., from upstream ISP stages) and performs a framing transformation to generate a scaled foreground 445. The crop-and-scale block 440 may implement a digital pan-tilt-zoom operation by selecting a foreground region of interest and scaling the foreground region of interest to a target output resolution. Thus, the subject can be centered and consistently sized across frames even when the camera is physically static. The scaled foreground 445 is provided as an input to a background replacement block 470 for compositing.

The background replacement block 470 includes a crop-and-upscale block 472 and a blender 474. The crop-and-upscale block 472 receives background content from the background store 465 and generates an upscaled background 476. In some examples, the crop-and-upscale block 472 selects a background crop that differs from the foreground crop used by the crop-and-scale block 440. The background can be made to translate and/or scale at a reduced rate relative to the foreground framing, thereby simulating depth-dependent parallax behavior. The resulting upscaled background 476 is provided to the blender 474 as a background-layer input.

Blending of the foreground and background layers can be determined, in part, based on a segmentation block 434, which generates a background map 436. In some examples, the background map 436 is derived from segmentation results and is provided to the blender 474 as a per-pixel mask indicating whether output pixels should be taken from the upscaled background 476 or from the scaled foreground 445. The background map 436 can provide for soft transitions at boundaries between the background and the foreground. In some examples, the blender 474 determines a composited output according to a weighted combination of background and foreground layers using a segmentation map, such as:

$$Out = BG \cdot {M}_{BG} + FG \cdot ( 1 - {M}_{BG} )$$

where BG corresponds to the upscaled background 476, FG corresponds to the scaled foreground 445, and M_{BG} corresponds to the background segmentation map 436.

The composited output produced by the background replacement block 470 is stored in an output store 480 and provided as an output image 485. In some examples, because the background is transformed using a crop distinct from the foreground framing crop, the output image 485 exhibits background motion that is less jumpy than a fully coupled one-to-one background transformation and is more visually cohesive than a fully static background. In some examples, the effect is a composited output that resembles footage captured by a physical camera operator tracking a subject, rather than the appearance of a digitally cropped static camera feed.

According to various implementations, the system 400 differs from the system 200 in the source and handling of background content and in the presence of the TNR-based background formation path. In FIG. 2, background content is supplied from an external background image (e.g., a user-selected synthetic scene) stored in a background memory, and a micro pipe and software process determine segmentation and crop parameters used to crop and transform both foreground and background for compositing. In FIG. 4, the system 400 instead includes the TNR block 420 and mask 430 to build and/or maintain a background in the background store 465, enabling use of an accumulated real-scene background plate as a background source for subsequent parallax-driven cropping and blending.

In some examples, the system of FIG. 2 is utilized for virtual background replacement scenarios because it can accept a synthetic or user-selected background image and apply a depth-controlled crop-and-upscale operation so that the replacement background pans and zooms at a different rate than the auto-framed subject, improving realism while remaining compatible with common conferencing features. In some examples, the system of FIG. 4 is utilized when a real-scene background is selected (e.g., a “background freeze” mode), because the TNR block 420, guided by the mask 430, can accumulate a clean background plate even while the subject remains present, and the background replacement block 470 can then apply parallax-consistent background motion to that plate to generate smoother, less distracting output during framing changes.

In various implementations, the system 200 and the system 400 both provide efficiency benefits by performing key operations within or closely coupled to the ISP pipeline, rather than using full-resolution post-processing on general-purpose compute resources. In some examples, the ISP-integrated approach reduces memory bandwidth, latency, and power consumption for real-time video, while enabling background motion control that avoids the extremes of a fully static background (which can appear pasted) and a fully coupled background (which can appear overly dynamic), thereby supporting a more natural depth impression without explicit three-dimensional geometry reconstruction.

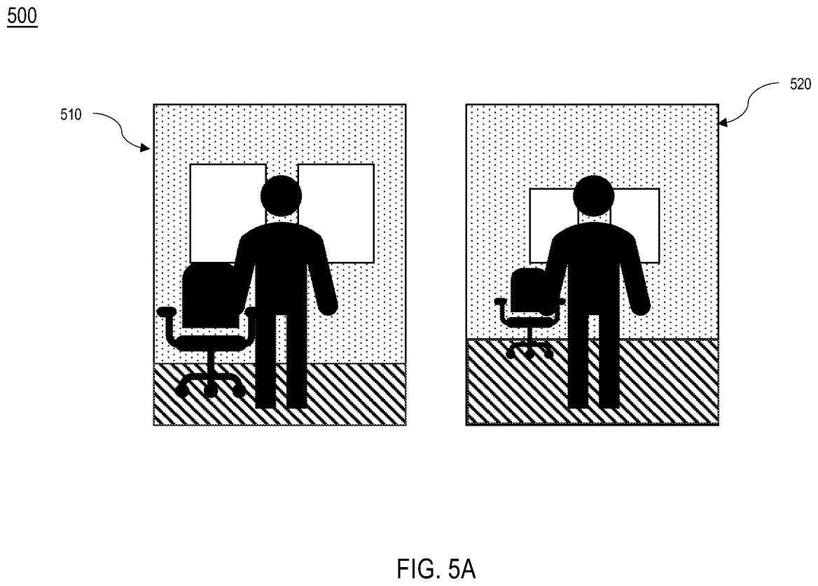

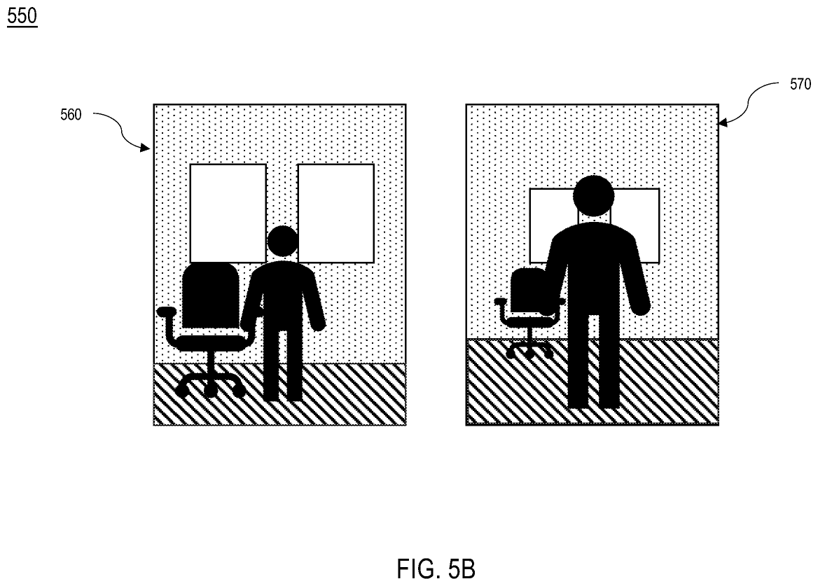

FIGS. 5A-5B illustrate example time-separated frames generated by a parallax engine, in accordance with various embodiments. The example time-separated frames illustrate the parallax engine operating in an extended mode, in which background scaling is intentionally varied over time to introduce visually perceptible depth dynamics. The background scaling examples can include scenarios in which conventional auto-framing triggers may be inactive or minimal. In the extended mode, a background layer and, optionally, a foreground layer, are independently scaled according to one or more configured functions, so that the resulting output exhibits a controlled zoom relationship between layers without explicit three-dimensional scene reconstruction.

FIG. 5A depicts an example static-scene enhancement in which background zoom variation is applied while the framed subject is maintained in a substantially stable pose and size. In particular, FIG. 5A shows a first frame 510 and a later frame 520, in which the depicted background region (e.g., wall texture and background objects) exhibits a gradual scale change across time. In some examples, the background scale is adjusted extremely gradually over an extended period according to a predefined function (e.g., linear or another function), thereby creating subtle visual motion that can improve viewer engagement while preserving a consistent and comfortable framing of the subject. In FIG. 5A, the background is zoomed out in the frame 520 as compared to the frame 510, while the foreground (the subject) remains at the same general scale.

In some examples, the behavior illustrated by FIG. 5A is implemented using the background manipulation architecture used for parallax framing. The background manipulation can use modified parameter-generation logic that supplies time-varying background scale values rather than background scale values derived from active subject motion or framing updates. In various examples, the system can treat the background as a separate layer whose crop and/or scale is adjusted to create a gentle zoom-in or zoom-out effect across successive frames, while maintaining output stability suitable for real-time communication scenarios.

FIG. 5B depicts an example coordinated multi-layer scaling mode in which both foreground and background layers are varied, potentially in complementary directions, to generate a stronger cinematic impression. In particular, FIG. 5B shows a first frame 560 and a later frame 570, illustrating that the subject and the background can be scaled differently across time so that the subject scale and background scale do not remain locked in a one-to-one relationship. In some examples, the background undergoes a slow zoom-out variation while the subject undergoes an independent zoom-in variation, thereby producing a combined effect that maintains viewer attention while still conveying a depth-like relationship between layers.

In some examples, the coordinated scaling of FIG. 5B is configured to emulate a cinematic dolly zoom-type effect in which the apparent magnification of the subject and the apparent magnification of the background evolve differently across frames. In one example, the subject is zoomed in while the background appears to change scale in a different manner, creating a dramatic visual effect while preserving a coherent composited frame. In another example, the background is adjusted while the subject remains substantially fixed in position, producing a visually interesting background motion that is less distracting than a fully coupled transformation applied equally to both layers.

In some examples, the sequences represented by frames 510/520 and 560/570 are generated by determining separate crop-and-scale parameters for background content and foreground content, applying the respective transforms to generate transformed background and transformed foreground layers, and compositing the layers using a segmentation mask. In this manner, FIGS. 5A-5B illustrate that the parallax engine can be used not only during auto-framing events driven by subject motion, but also as a time-driven enhancement mechanism that introduces controlled, aesthetically pleasing depth dynamics in otherwise static scenes, using the same underlying independent-layer transformation approach.

Example Method for Auto-Framing over Replaced Backgrounds

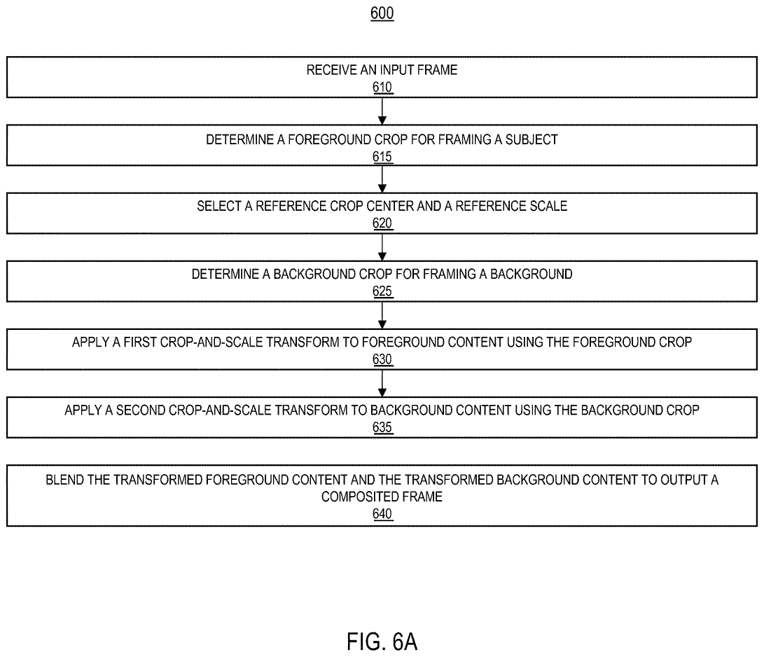

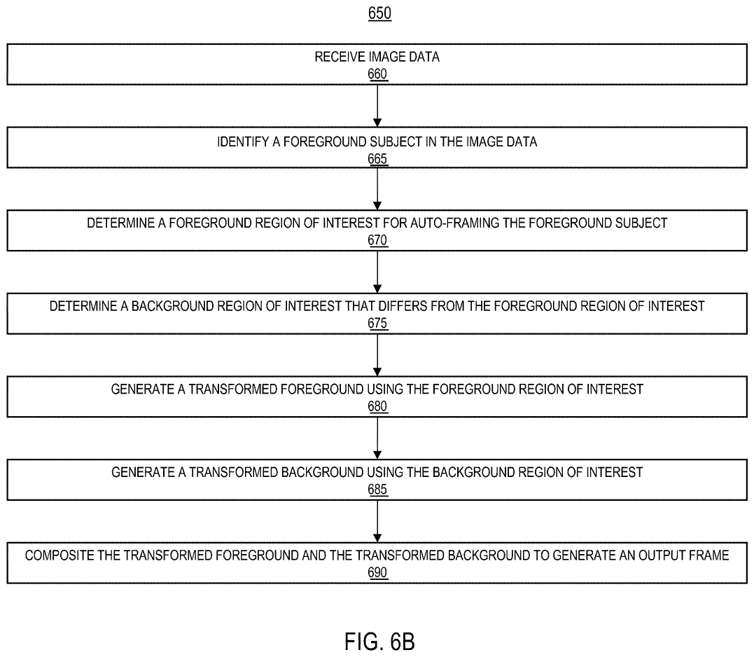

FIGS. 6A-6B are flowcharts showing methods 600, 650 for auto-framing over replaced backgrounds, in accordance with various embodiments. Although the methods 600, 650 are described with reference to the flowcharts illustrated in FIGS. 6A-6B, many other methods for auto-framing over replaced backgrounds may alternatively be used. For example, the order of execution of the elements in FIGS. 6A-6B may be changed. As another example, some of the steps may be changed, eliminated, or combined. In various examples, the methods 600, 650 can be implemented by a system for auto-framing over replaced backgrounds, such as the system 200 of FIG. 2 and/or the system 400 of FIG. 4.

FIG. 6A is a flowchart showing the method 600 for auto-framing over replaced backgrounds. At 610, an input frame is received. In some examples, the input frame is received from an image capture pipeline and represents a current video frame to be processed for subject framing and background replacement. At 615, a foreground crop is determined for framing a subject. In some examples, the foreground crop center is determined based on a foreground crop center and a foreground scale. In some examples, the foreground crop is generated by a user-framing function that tracks the subject location over time and outputs parameters that maintain the subject within a selected portion of an output frame while meeting a target output resolution.

At 620, a reference crop center and a reference scale are selected. In some examples, the reference crop center corresponds to a neutral location in an image coordinate system, such as an image center, and the reference scale corresponds to a wide-view scale, such as an un-zoomed scale that preserves more of a background field of view. In some examples, the reference values (i.e., the reference crop center and reference scale) define a limiting case in which background motion is minimized and the background remains substantially static relative to the output frame.

At 625, a background crop is determined for framing the background. The background crop is based on a background crop center and a background scale. The background crop center is determined based on the foreground crop center and the reference crop center. The background scale is determined based on the foreground scale and the reference scale. In some examples, the background crop center is determined by interpolating between the foreground crop center and the reference crop center using a tunable depth parameter f, such that the background crop center follows the subject motion with reduced magnitude. In some examples, the background scale is determined by interpolating between the foreground scale and the reference scale using the tunable depth parameter f, thereby causing the background to exhibit reduced magnification relative to the subject during zoom operations. In some examples, the tunable depth parameter f is selected in a range between endpoints that correspond to coupled foreground/background behavior and substantially fixed background behavior. In some examples, the selection of the tunable depth parameter f can be performed manually to achieve a visually pleasing depth impression.

At 630, a first crop-and-scale transform is applied to foreground content using the foreground crop. At 635, a second crop-and-scale transform is applied to background content using the background crop. In some examples, applying the first crop-and-scale transform produces transformed foreground content that keeps the subject centered and consistently sized, while applying the second crop-and-scale transform produces transformed background content that pans and/or zooms at a different rate than the transformed foreground content, thereby synthesizing parallax and zoom-compression cues without constructing explicit three-dimensional scene geometry. In some examples, the background transform may crop a different portion of the background, or may use a different crop size than the foreground transform, and the background transform may vary dynamically over time as the foreground crop changes.

At 640, the transformed foreground content and the transformed background content are blended to output a composited frame. In some examples, blending is determined based on a segmentation map that separates foreground from background, and the composited frame is generated according to a weighted combination of the foreground and the background based on the segmentation map. In some examples, segmentation artifacts at boundaries are tolerated in a manner consistent with other background replacement systems, and the blending operation may use soft mask values to reduce visible edges.

FIG. 6B is a flowchart illustrating a method 650 for auto-framing over replaced backgrounds. At 660, image data is received. At 665, a foreground subject is identified in the image data. In some examples, identifying the foreground subject is performed using a detection function and/or segmentation function that outputs a subject location and a mask, and the identification can support auto-framing for a single subject or for multiple subjects. For example, when multiple subjects are present, the identification may select an active speaker to frame or may identify a combined region that includes multiple subjects.

At 670, a foreground region of interest is determined for auto-framing the foreground subject. At 675, a background region of interest is determined that differs from the foreground region of interest. In some examples, the foreground region of interest corresponds to a crop that is sized and positioned to keep the subject within a target framing window, and the background region of interest corresponds to a separate crop that is biased toward a reference center and/or reference scale using a depth parameter so that background translation and scaling are attenuated relative to the foreground.

At 680, a transformed foreground is generated using the foreground region of interest. At 685, a transformed background is generated using the background region of interest. In some examples, the foreground transformation and the background transformation are implemented using crop-and-scale operations that output foreground and background layers at a common target resolution, allowing for direct compositing. At 690, the transformed foreground and the transformed background are composited to generate an output frame. In some examples, the compositing operation reduces visual artifacts associated with backgrounds that are entirely static or backgrounds that move in a fully coupled one-to-one relationship with foreground framing, by generating an intermediate depth impression in which background motion is reduced relative to subject motion.

In some examples, in the method 600 and the method 650, operations associated with foreground subject identification, segmentation, and region-of-interest determination are performed using a low-resolution analysis path, while operations associated with crop-and-scale and compositing are performed in a high-throughput imaging pipeline. Performing operations in the low-resolution analysis path and the high-throughput imaging pipeline reduces bandwidth, latency, and power in real-time video processing relative to fully software-based post-processing. In some examples, a background replacement block receives a background image, a mask, and region-of-interest information and performs background-specific manipulations, including cropping and upscaling a different portion of the background than the portion implied by the foreground framing, thereby enabling parallax behavior that would otherwise be unavailable when framing is performed before post-processing.

### Example DNN

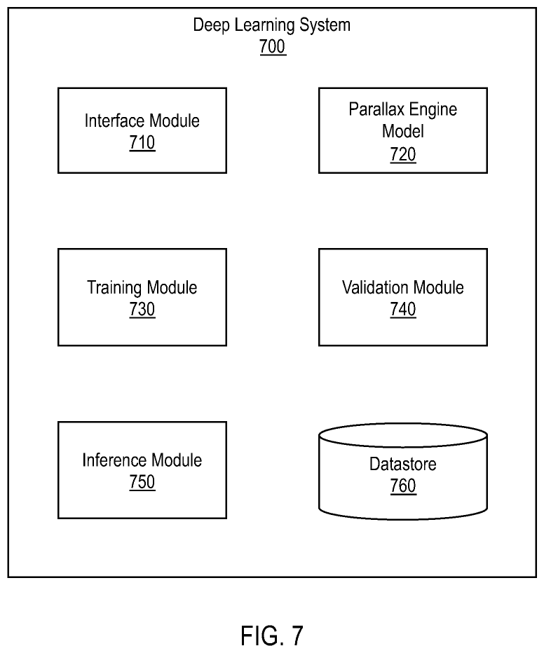

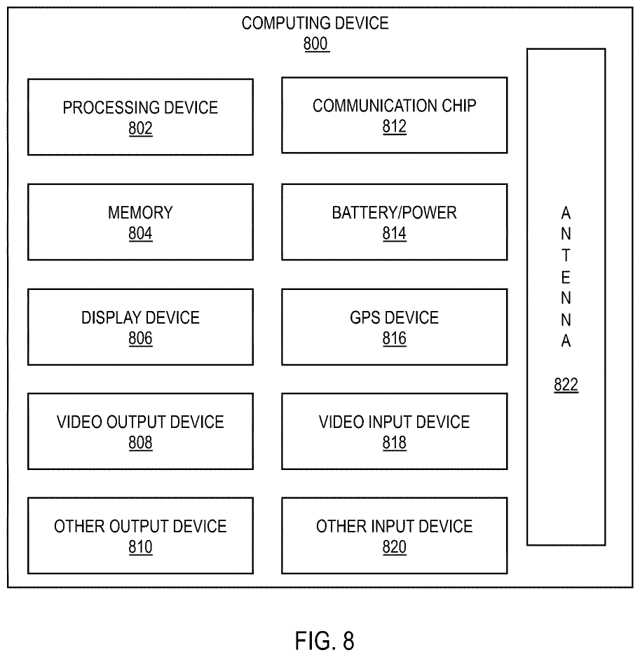

FIG. 7 is a block diagram of an example DNN system 700, in accordance with various embodiments. The DNN system 700 trains DNNs for various tasks, including auto-framing over replaced backgrounds for video. The DNN system 700 includes an interface module 710, a parallax engine model 720, a training module 730, a validation module 740, an inference module 750, and a datastore 760. In other embodiments, alternative configurations, different or additional components may be included in the DNN system 700. Further, functionality attributed to a component of the DNN system 700 may be accomplished by a different component included in the DNN system 700 or a different system. The DNN system 700 or a component of the DNN system 700 (e.g., the training module 730 or inference module 750) may include the computing device 800 in FIG. 8.

The interface module 710 facilitates communication of the DNN system 700 with other systems. As an example, the interface module 710 supports the DNN system 700 to distribute trained DNNs to other systems, e.g., computing devices configured to apply DNNs to perform tasks. As another example, the interface module 710 establishes communication between the DNN system 700 and an external database to receive data that can be used to train DNNs or input into DNNs to perform tasks. In some embodiments, data received by the interface module 710 may have a data structure, such as a matrix. In some embodiments, data received by the interface module 710 may be an image, a series of images, and/or a video stream.

The parallax engine model 720 processes image data (e.g., one or more video frames) to support auto-framing over replaced backgrounds. In some examples, the parallax engine model 720 includes one or more DNNs configured to identify a foreground subject and/or generate a segmentation mask separating foreground and background. In some examples, the parallax engine model 720 determines a foreground region of interest for framing the foreground subject and determines a background region of interest that differs from the foreground region of interest such that background translation and/or background scaling is attenuated relative to foreground motion. In some examples, the parallax engine model 720 outputs one or more of a foreground crop (e.g., a foreground crop center and a foreground scale), a background crop (e.g., a background crop center and a background scale determined using a depth parameter), and a segmentation mask used to composite transformed foreground content with transformed background content in an output frame.

The training module 730 trains DNNs by using training datasets. In some embodiments, a training dataset for training a DNN may include one or more images and/or videos, each of which may be a training sample. In some examples, the training module 730 trains the parallax engine model 720. The training module 730 may receive real-world image data for processing with the parallax engine model 720 as described herein. In some embodiments, the training module 730 may input different data into different layers of the DNN. For every subsequent DNN layer, the input data may be less than the previous DNN layer. In some examples, the parallax engine model 720 can be trained with ground-truth foreground/background maps of images. In some examples, the difference between the parallax engine model 720 foreground classification map output and the corresponding ground-truth foreground classification map can be measured as the number of pixels in the corresponding maps that have different classifications from each other.

In some embodiments, a part of the training dataset may be used to initially train the DNN, and the rest of the training dataset may be held back as a validation subset used by the validation module 740 to validate performance of a trained DNN. The portion of the training dataset not including the tuning subset and the validation subset may be used to train the DNN.

The training module 730 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as the number of hidden layers, etc. Hyperparameters also include variables that determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 730 defines the architecture of the DNN, e.g., based on some of the hyperparameters. The architecture of the DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of the input image after convolution. It is used between two convolutional layers. A fully connected layer involves weights, biases, and neurons. It connects neurons in one layer to neurons in another layer. It is used to classify images between different categories by training.

In the process of defining the architecture of the DNN, the training module 730 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 730 defines the architecture of the DNN, the training module 730 inputs a training dataset into the DNN. The training dataset includes a plurality of training samples. An example of a training dataset includes a series of images of a video stream. Unlabeled, real-world video is input to the parallax engine model 720, and processed using the parallax engine model 720 parameters of the DNN to produce model-generated outputs. In some embodiments, the training module 730 uses a cost function to minimize the differences.

The training module 730 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 730 finishes the predetermined number of epochs, the training module 730 may stop updating the parameters in the DNN. The DNN having the updated parameters is referred to as a trained DNN.

The validation module 740 verifies the accuracy of trained DNNs. In some embodiments, the validation module 740 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 740 may determine an accuracy score measuring the precision, recall, or a combination of precision and recall of the DNN. The validation module 740 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 740 may compare the accuracy score with a threshold score. In an example where the validation module 740 determines that the accuracy score of the augmented model is lower than the threshold score, the validation module 740 instructs the training module 730 to re-train the DNN. In one embodiment, the training module 730 may iteratively re-train the DNN until the occurrence of a stopping condition, such as the accuracy measurement indicating that the DNN may be sufficiently accurate, or a number of training rounds having taken place.

The inference module 750 applies the trained or validated DNN to perform tasks. The inference module 750 may run inference processes of a trained or validated DNN. In some examples, inference makes use of the forward pass to produce model-generated output for unlabeled real-world data. For instance, the inference module 750 may input real-world data into the DNN and receive an output of the DNN. The output of the DNN may provide a solution to the task for which the DNN is trained.

The inference module 750 may aggregate the outputs of the DNN to generate a final result of the inference process. In some embodiments, the inference module 750 may distribute the DNN to other systems, e.g., computing devices in communication with the DNN system 700, for the other systems to apply the DNN to perform the tasks. The distribution of the DNN may be done through the interface module 710. In some embodiments, the DNN system 700 may be implemented in a server, such as a cloud server, an edge service, and so on. The computing devices may be connected to the DNN system 700 through a network. Examples of the computing devices include edge devices.

The datastore 760 stores data received, generated, used, or otherwise associated with the DNN system 700. For example, the datastore 760 stores video processed by the parallax engine model 720 or used by the training module 730, validation module 740, and the inference module 750. The datastore 760 may also store other data generated by the training module 730 and validation module 740, such as the hyperparameters for training DNNs, internal parameters of trained DNNs (e.g., values of tunable parameters of activation functions, such as Fractional Adaptive Linear Units (FALUs)), etc. In the embodiment of FIG. 7, the datastore 760 is a component of the DNN system 700. In other embodiments, the datastore 760 may be external to the DNN system 700 and communicate with the DNN system 700 through a network.

For parallax engine model 720 training, the input can include an input image frame and one or more labeled targets associated with auto-framing over replaced backgrounds. In various examples, the labeled targets include a foreground/background segmentation mask and/or foreground crop parameters used to frame a subject. In various examples, the labeled targets include background crop parameters computed to differ from the foreground crop, including a background crop center and a background scale determined using a depth parameter to attenuate background translation and/or background scaling relative to the subject. In other examples, the input image frame can be received at the training module 730 or the inference module 750 of FIG. 7, and the output of the parallax engine model 720 provides crop and/or mask information used by a background replacement pipeline to composite a transformed foreground with a transformed background. The imager can be a camera, such as a video camera. The input image frame can be a still image from the video camera feed. The input image frame can include a matrix of pixels, each pixel having a color, lightness, and/or other parameter. In some embodiments, one or more loss functions are used to reduce differences between model-generated outputs and the labeled targets, including differences between model-generated segmentation outputs and labeled segmentation masks and/or differences between model-generated crop outputs and labeled crop parameters.

### Example Computing Device

FIG. 8 is a block diagram of an example computing device 800, in accordance with various embodiments. In some embodiments, the computing device 800 may be used for at least part of the deep learning system 700 in FIG. 7. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include a video input device 818 or a video output device 808, but may include video input or output device interface circuitry (e.g., connectors and supporting circuitry) to which a video input device 818 or video output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 804 may include memory that shares a die with the processing device 802. In some embodiments, the memory 804 includes one or more non-transitory computer-readable media storing instructions executable for auto-framing for replaced backgrounds, e.g., the method 600 described above in conjunction with FIG. 6A, the method 650 described in conjunction with FIG. 6B, or some operations performed by the parallax engine system 200 in FIG. 2, the parallax engine system 400 in FIG. 4 or the DNN system 700 in FIG. 7. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include a video output device 808 (or corresponding interface circuitry, as discussed above). The video output device 808 may include any device that generates an audible indicator, such as speakers, headsets, or earbuds, for example.

The computing device 800 may include a video input device 818 (or corresponding interface circuitry, as discussed above). The video input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include a video codec, a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

### Selected Examples

The following paragraphs provide various examples of the embodiments disclosed herein.

Example 1 provides an apparatus, including a computer processor for executing computer program instructions; and a non-transitory computer-readable memory storing computer program instructions executable by the computer processor to perform operations including receiving an input frame; determining a foreground crop for framing a subject, where the foreground crop is based on a foreground crop center and a foreground scale; determining a background crop for framing a background layer, where the background crop is based on a background crop center and a background scale, and where at least one of the background crop center and the background scale is determined separate from the foreground crop; applying, at a foreground crop-and-scale block of an image signal processor, a first crop-and-scale transform to foreground content using the foreground crop to generate transformed foreground content; applying, at a crop-and-upscale block of a background replacement block coupled to the image signal processor, a second crop-and-scale transform to background content using the background crop to generate transformed background content; and blending the transformed foreground content and the transformed background content to output a composited frame.

Example 2 provides the apparatus of example 1, further including selecting a reference crop center and a reference scale, where determining the background crop includes determining a background crop center based on the foreground crop center and the reference crop center.

Example 3 provides the apparatus of example 2, where determining the background crop center includes determining the background crop center as an interpolation between the foreground crop center and the reference crop center.

Example 4 provides the apparatus of example 3, where the interpolation is a linear interpolation based on a depth parameter.

Example 5 provides the apparatus of any one of examples 2-4, where determining the background crop includes determining the background scale based on the foreground scale and the reference scale.

Example 6 provides the apparatus of example 5, where determining the background scale includes determining the background scale as an interpolation between the foreground scale and the reference scale.

Example 7 provides the apparatus of any one of examples 1-6, where determining the background crop center includes determining the background crop center using a depth parameter, and where determining the background scale includes determining the background scale using the depth parameter.

Example 8 provides the apparatus of example 7, where the depth parameter has a value selected from a range bounded by a first endpoint at which the background crop center substantially coincides with the foreground crop center and a second endpoint at which the background crop center substantially coincides with a reference crop center.

Example 9 provides the apparatus of any one of examples 1-8, where the operations further include generating a reduced-resolution representation of the input frame; and determining the foreground crop using the reduced-resolution representation.

Example 10 provides the apparatus of example 9, where the operations further include performing background segmentation on the reduced-resolution representation to generate a segmentation mask; and where blending the transformed foreground content and the transformed background content includes blending based in part on the segmentation mask.

Example 11 provides the apparatus of any one of examples 1-10, where the input frame is one of a plurality of input frames, and where the operations further include receiving the plurality of input frames; and time-varying the background scale across successive input frames of the plurality of input frames according to a predefined function, while the foreground scale remains substantially constant across the successive input frames, such that an apparent zoom of the background changes over time independent of subject motion.

Example 12 provides the apparatus of any one of examples 1-11, where the second crop-and-scale transform is performed within a background replacement block that also performs the blending, the background replacement block being separate from a foreground crop-and-scale block that performs the first crop-and-scale transform.

Example 13 provides the apparatus of any one of examples 1-12, where the first crop-and-scale transform crops a region of the foreground content, the second crop-and-scale transform crops a region of the background content, where the region of the background content is larger than the region of the foreground content, and further including upscaling the region of the background content to a target output resolution.

Example 14 provides the apparatus of any one of examples 1-13, where identifying a foreground subject for which the foreground crop is determined includes selecting one subject from among a plurality of subjects identified in the input frame, the selected subject being identified as an active speaker.

Example 15 provides the apparatus of any one of examples 1-14, where the background content includes a synthetic image selected by a user from a plurality of available background images, the second crop-and-scale transform being applied to the synthetic image to generate the transformed background content.

Example 16 provides the apparatus of any one of examples 1-14, wherein the background layer includes a captured real-scene background from a physical environment represented in the input frame, wherein the captured real-scene background is generated at a temporal noise reduction block of the image signal processor, and wherein the temporal noise reduction block updates a stored background.

Example 17 provides the apparatus of example 16, wherein the temporal noise reduction block updates the stored background using a mask that distinguishes foreground regions from background regions.

Example 18 provides the apparatus of example 17, wherein the temporal noise reduction block suppresses updating of the stored background in the foreground regions and updates the stored background in the background regions.

Example 19 provides the apparatus of any one of examples 1-18, wherein determining the foreground crop comprises identifying a plurality of subjects in the input frame and determining the foreground crop to frame the plurality of subjects.

Example 20 provides the apparatus of any one of examples 1-19, wherein determining the foreground crop comprises selecting one subject from among a plurality of subjects identified in the input frame, the selected subject being identified as an active speaker.

Example 21 provides the apparatus of any one of examples 1-20, wherein the foreground crop is updated to transition between different active speakers over time, and wherein the background crop is updated during the transition using the background crop center or the background scale.

Example 22 provides one or more non-transitory computer-readable media storing instructions executable to perform operations, the operations including receiving an input frame; determining a foreground crop for framing a subject, where the foreground crop is based on a foreground crop center and a foreground scale; determining a background crop for framing a background layer, where the background crop is based on a background crop center and a background scale, and where at least one of the background crop center and the background scale is determined separate from the foreground crop; applying, at a foreground crop-and-scale block of an image signal processor, a first crop-and-scale transform to foreground content using the foreground crop to generate transformed foreground content; applying, at a crop-and-upscale block of a background replacement block coupled to the image signal processor, a second crop-and-scale transform to background content using the background crop to generate transformed background content; and blending the transformed foreground content and the transformed background content to output a composited frame.

Example 23 provides the one or more non-transitory computer-readable media of example 22, where the operations further include selecting a reference crop center and a reference scale, where determining the background crop includes determining a background crop center based on the foreground crop center and the reference crop center.

Example 24 provides the one or more non-transitory computer-readable media of example 23, where determining the background crop center includes determining the background crop center as an interpolation between the foreground crop center and the reference crop center.

Example 25 provides the one or more non-transitory computer-readable media of example 23 or 24, where determining the background crop includes determining the background scale based on the foreground scale and the reference scale.

Example 26 provides the one or more non-transitory computer-readable media of example 25, where determining the background scale includes determining the background scale as an interpolation between the foreground scale and the reference scale.

Example 27 provides the one or more non-transitory computer-readable media of any one of examples 22-26, where determining the background crop center includes determining the background crop center using a depth parameter, and where determining the background scale includes determining the background scale using the depth parameter.

Example 28 provides the one or more non-transitory computer-readable media of example 27, where the depth parameter has a value selected from a range bounded by a first endpoint at which the background crop center substantially coincides with the foreground crop center and a second endpoint at which the background crop center substantially coincides with a reference crop center.

Example 29 provides the one or more non-transitory computer-readable media of any one of examples 22-28, where the operations further include generating, by a low-power processing path of an image signal processor, a reduced-resolution representation of the input frame; and determining the foreground crop using the reduced-resolution representation.

Example 30 provides the one or more non-transitory computer-readable media of example 29, where the operations further include performing background segmentation on the reduced-resolution representation to generate a segmentation mask; and where blending the transformed foreground content and the transformed background content includes blending based in part on the segmentation mask.

Example 31 provides the one or more non-transitory computer-readable media of any one of examples 22-30, where the input frame is one of a plurality of input frames, and where the operations further include receiving the plurality of input frames; and time-varying the background scale across successive input frames of the plurality of input frames according to a predefined function, while the foreground scale remains substantially constant across the successive input frames, such that an apparent zoom of the background changes over time independent of subject motion.

Example 32 provides the one or more non-transitory computer-readable media of any one of examples 22-31, where the second crop-and-scale transform is performed within a background replacement block that also performs the blending, the background replacement block being separate from a foreground crop-and-scale block that performs the first crop-and-scale transform.

Example 33 provides the one or more non-transitory computer-readable media of any one of examples 22-32, where the first crop-and-scale transform crops a region of the foreground content, where the second crop-and-scale transform crops a region of the background content, where the region of the background content is larger than the region of the foreground content, and further including upscaling the region of the background content to a target output resolution.

Example 34 provides the one or more non-transitory computer-readable media of any one of examples 22-33, where identifying a foreground subject for which the foreground crop is determined includes selecting one subject from among a plurality of subjects identified in the input frame, the selected subject being identified as an active speaker.

Example 35 provides the one or more non-transitory computer-readable media of example 22, where the background content includes a synthetic image selected by a user from a plurality of available background images, the second crop-and-scale transform being applied to the synthetic image to generate the transformed background content.

Example 36 provides a computer-implemented method including receiving an input frame; determining a foreground crop for framing a subject, where the foreground crop is based on a foreground crop center and a foreground scale; determining a background crop for framing a background layer, where the background crop is based on a background crop center and a background scale, and where at least one of the background crop center and the background scale is determined separate from the foreground crop; applying, at a foreground crop-and-scale block of an image signal processor, a first crop-and-scale transform to foreground content using the foreground crop to generate transformed foreground content; applying, at a crop-and-upscale block of a background replacement block coupled to the image signal processor, a second crop-and-scale transform to background content using the background crop to generate transformed background content; and blending the transformed foreground content and the transformed background content to output a composited frame.

Example 37 provides the computer-implemented method of example 36, further including selecting a reference crop center and a reference scale, where determining the background crop includes determining a background crop center based on the foreground crop center and the reference crop center.

Example 38 provides the computer-implemented method of example 37, where determining the background crop center includes determining the background crop center as an interpolation between the foreground crop center and the reference crop center.

Example 39 provides the computer-implemented method of any one of examples 37-38, where determining the background crop includes determining the background scale based on the foreground scale and the reference scale.

Example 40 provides the computer-implemented method of example 39, where determining the background scale includes determining the background scale as an interpolation between the foreground scale and the reference scale.

Example 41 provides the computer-implemented method of any one of examples 36-40, where determining the background crop center includes determining the background crop center using a depth parameter, and where determining the background scale includes determining the background scale using the depth parameter.

Example 42 provides the computer-implemented method of example 41, where the depth parameter has a value selected from a range bounded by a first endpoint at which the background crop center substantially coincides with the foreground crop center and a second endpoint at which the background crop center substantially coincides with a reference crop center.

Example 43 provides the computer-implemented method of any one of examples 36-42, further including generating a reduced-resolution representation of the input frame; and determining the foreground crop using the reduced-resolution representation.

Example 44 provides the computer-implemented method of example 43, further including performing background segmentation on the reduced-resolution representation to generate a segmentation mask; and where blending the transformed foreground content and the transformed background content includes blending based in part on the segmentation mask.

Example 45 provides the computer-implemented method of any one of examples 36-44, where the input frame is one of a plurality of input frames, and further including receiving the plurality of input frames; and time-varying the background scale across successive input frames of the plurality of input frames according to a predefined function, while the foreground scale remains substantially constant across the successive input frames, such that an apparent zoom of the background changes over time independent of subject motion.

Example 46 provides the computer-implemented method of any one of examples 36-45, where the second crop-and-scale transform is performed within a background replacement block that also performs the blending, the background replacement block being separate from a foreground crop-and-scale block that performs the first crop-and-scale transform.

Example 47 provides the computer-implemented method of any one of examples 36-46, where the first crop-and-scale transform crops a region of the foreground content, where the second crop-and-scale transform crops a region of the background content, where the region of the background content is larger than the region of the foreground content, and further including upscaling the region of the background content to a target output resolution.

Example 48 provides the computer-implemented method of any one of examples 36-47, where identifying a foreground subject for which the foreground crop is determined includes selecting one subject from among a plurality of subjects identified in the input frame, the selected subject being identified as an active speaker.

Example 49 provides the computer-implemented method of any one of examples 36-48, where the background content includes a synthetic image selected by a user from a plurality of available background images, the second crop-and-scale transform being applied to the synthetic image to generate the transformed background content.

Example 50 provides an apparatus, including a computer processor for executing computer program instructions; and a non-transitory computer-readable memory storing computer program instructions executable by the computer processor to perform operations including receiving image data; identifying a foreground subject in the image data; determining a foreground region of interest for auto-framing the foreground subject; determining a background region of interest that differs from the foreground region of interest; generating a transformed foreground using the foreground region of interest; generating a transformed background using the background region of interest; and compositing the transformed foreground and the transformed background to generate an output frame.

Example 51 provides the apparatus of example 50, where the operations further include generating a segmentation mask separating foreground from background.

Example 52 provides the apparatus of example 51, where compositing the transformed foreground and the transformed background includes using the segmentation mask.

Example 53 provides the apparatus of example 51 or 52, where determining the background region of interest includes determining the background region of interest based on a depth parameter.

Example 54 provides the apparatus of any one of examples 51-53, where at least one of background translation and background scaling is attenuated relative to the foreground region of interest.

Example 55 provides an image processing system, including an image signal processor configured to receive an input frame from an image capture pipeline; an analysis path coupled to the image signal processor and configured to generate, from the input frame, (i) a foreground region of interest defining a foreground crop center and a foreground scale for framing a subject and (ii) a segmentation mask separating foreground content from background content; a foreground crop-and-scale block within the image signal processor and configured to apply a crop-and-scale transform to the foreground content according to the foreground region of interest, to generate a transformed foreground; and a background replacement block coupled to the image signal processor and configured to receive background content and to generate a transformed background and a composited output frame, the background replacement block including a crop-and-upscale block configured to apply a crop-and-upscale transform to the background content according to a background region of interest that defines a background crop center and a background scale, the background region of interest being determined separate from the foreground region of interest, and a blender configured to combine the transformed foreground and the transformed background according to the segmentation mask to generate the composited output frame.

Example 56 provides the image processing system of example 55, where the analysis path includes a low-power processing path of the image signal processor configured to generate a reduced-resolution representation of the input frame, the foreground region of interest, the background region of interest, and the segmentation mask each being determined using the reduced-resolution representation, while the crop-and-scale transform and the crop-and-upscale transform are applied to a higher-resolution representation of the input frame.

Example 57 provides the image processing system of example 55 or 56, further including a temporal noise reduction block within the image signal processor and configured to maintain, in a background store, a real-scene background plate accumulated across a plurality of input frames, the temporal noise reduction block being biased by the segmentation mask to suppress accumulation in regions identified as foreground; the background content received by the background replacement block including the real-scene background plate.

Example 58 provides the image processing system of any one of examples 55-57, further including a background store configured to provide a synthetic background image as the background content received by the background replacement block.

Example 59 provides the image processing system of any one of examples 55-58, where the background region of interest is determined by interpolation between (i) the foreground region of interest and (ii) a reference region of interest including at least one of a reference crop center and a reference scale, the interpolation being controlled by a depth parameter.

Example 60 provides a computer-implemented system for generating a composited video frame, the system including one or more processors; and one or more non-transitory computer-readable media storing instructions that, when executed by the one or more processors, cause the one or more processors to perform operations including receiving an input frame and a depth parameter, the depth parameter having a value within a range bounded by a first endpoint and a second endpoint; determining a foreground crop center and a foreground scale for a subject in the input frame; selecting a reference crop center and a reference scale; determining a background crop center by interpolating between the foreground crop center and the reference crop center as a function of the depth parameter; determining a background scale by interpolating between the foreground scale and the reference scale as a function of the depth parameter, such that the background crop center coincides with the foreground crop center and the background scale coincides with the foreground scale when the depth parameter is at the first endpoint, and the background crop center coincides with the reference crop center and the background scale coincides with the reference scale when the depth parameter is at the second endpoint; generating transformed foreground content by applying a first crop-and-scale transform to foreground content of the input frame using the foreground crop center and the foreground scale; generating transformed background content by applying a second crop-and-scale transform to background content using the background crop center and the background scale; and compositing the transformed foreground content and the transformed background content using a segmentation mask to generate the composited video frame.

Example 61 provides the system of example 60, where the interpolation between the foreground crop center and the reference crop center is a linear interpolation, and where the interpolation between the foreground scale and the reference scale is a linear interpolation.

Example 62 provides the system of example 60 or 61, where the depth parameter is a single scalar f having a value in the range [0, 1], where the first endpoint corresponds to f=0 and the second endpoint corresponds to f=1, and where, at intermediate values of f, the background content translates by a smaller amount and zooms by a smaller amount than the foreground content during, respectively, a digital pan operation and a digital zoom operation.

Example 63 provides the system of any one of examples 60-62, where the operations further include time-varying the depth parameter across successive input frames such that the apparent depth relationship between the foreground content and the background content changes over time within a single video stream.

Example 64 provides an image processing apparatus, comprising an image signal processor comprising a foreground crop-and-scale block; a background replacement block coupled to the image signal processor and comprising a crop-and-upscale block and a blender; and one or more processors configured to perform operations comprising: receiving an input frame; determining a foreground crop for framing a subject, wherein the foreground crop is based on a foreground crop center and a foreground scale; determining a background crop for framing a background layer, wherein the background crop is based on a background crop center and a background scale, and wherein the background crop center and the background scale are determined separate from the foreground crop; applying, at a foreground crop-and-scale block of an image signal processor, a first crop-and-scale transform to foreground content using the foreground crop to generate transformed foreground content; applying, at a crop-and-upscale block of a background replacement block coupled to the image signal processor, a second crop-and-scale transform to background content using the background crop to generate transformed background content; and blending, by a blender of the background replacement block, the transformed foreground content and the transformed background content to output a composited frame.

Example 65 provides an apparatus, including a computer processor for executing computer program instructions; and a non-transitory computer-readable memory storing computer program instructions executable by the computer processor to perform operations including receiving, at an image signal processor, an input frame; generating, by a low-power processing path of the image signal processor, a reduced-resolution representation of the input frame; determining, using the reduced-resolution representation, a foreground crop for framing a subject, where the foreground crop is based on a foreground crop center and a foreground scale; determining a background crop for framing a background layer, where the background crop is based on a background crop center and a background scale, and where at least one of the background crop center and the background scale is determined separate from the foreground crop; applying, by a foreground crop-and-scale block of the image signal processor, a first crop-and-scale transform to foreground content using the foreground crop to generate transformed foreground content; applying, by a crop-and-upscale block of a background replacement block coupled to the image signal processor, a second crop-and-scale transform to background content using the background crop to generate transformed background content; and blending, by a blender of the background replacement block, the transformed foreground content and the transformed background content to output a composited frame.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
a computer processor for executing computer program instructions; and
a non-transitory computer-readable memory storing computer program instructions executable by the computer processor to perform operations comprising:
receiving an input frame;
determining a foreground crop for framing a subject, wherein the foreground crop is based on a foreground crop center and a foreground scale;
determining a background crop for framing a background layer, wherein the background crop is based on a background crop center and a background scale, and wherein the background crop center and the background scale are determined separate from the foreground crop;
applying, at a foreground crop-and-scale block of an image signal processor, a crop-and-scale transform to foreground content using the foreground crop to generate transformed foreground content;
applying, at a crop-and-upscale block of a background replacement block coupled to the image signal processor, a crop-and-upscale transform to background content using the background crop to generate transformed background content; and
blending the transformed foreground content and the transformed background content to output a composited frame.

2. The apparatus of claim 1, wherein the operations further comprise selecting a reference crop center and a reference scale, and wherein determining the background crop includes determining a background crop center based on the foreground crop center and the reference crop center.

3. The apparatus of claim 2, wherein determining the background crop center includes determining the background crop center as an interpolation between the foreground crop center and the reference crop center.

4. The apparatus of claim 2, wherein determining the background crop includes determining the background scale based on the foreground scale and the reference scale.

5. The apparatus of claim 4, wherein determining the background scale includes determining the background scale as an interpolation between the foreground scale and the reference scale.

6. The apparatus of claim 1, wherein determining the background crop center includes determining the background crop center using a depth parameter, and wherein determining the background scale includes determining the background scale using the depth parameter.

7. The apparatus of claim 6, wherein the depth parameter has a value selected from a range bounded by a first endpoint at which the background crop center substantially coincides with the foreground crop center and a second endpoint at which the background crop center substantially coincides with a reference crop center.

8. The apparatus of claim 1, wherein the image signal processor includes a low-power processing path, and wherein the operations further comprise:
generating, at the low-power processing path, a reduced-resolution representation of the input frame; and
determining the foreground crop using the reduced-resolution representation.

9. The apparatus of claim 1, wherein the background layer includes a captured real-scene background from a physical environment represented in the input frame, wherein the captured real-scene background is generated at a temporal noise reduction block of the image signal processor, and wherein the temporal noise reduction block updates a stored background.

10. The apparatus of claim 9, wherein the temporal noise reduction block updates the stored background using a mask that distinguishes foreground regions from background regions.

11. The apparatus of claim 10, wherein the temporal noise reduction block suppresses updating of the stored background in the foreground regions and updates the stored background in the background regions.

12. One or more non-transitory computer-readable media storing instructions executable to perform operations, the operations comprising:
receiving an input frame;
determining a foreground crop for framing a subject, wherein the foreground crop is based on a foreground crop center and a foreground scale;
determining a background crop for framing a background layer, wherein the background crop is based on a background crop center and a background scale, and wherein at least one of the background crop center and the background scale is determined separate from the foreground crop;
applying, at a foreground crop-and-scale block of an image signal processor, a crop-and-scale transform to foreground content using the foreground crop to generate transformed foreground content;
applying, at a crop-and-upscale block of a background replacement block coupled to the image signal processor, a crop-and-upscale transform to background content using the background crop to generate transformed background content; and
blending the transformed foreground content and the transformed background content to output a composited frame.

13. The one or more non-transitory computer-readable media of claim 12, wherein the operations further comprise selecting a reference crop center and a reference scale, wherein determining the background crop includes determining a background crop center based on the foreground crop center and the reference crop center.

14. The one or more non-transitory computer-readable media of claim 13, wherein determining the background crop center includes determining the background crop center as an interpolation between the foreground crop center and the reference crop center.

15. The one or more non-transitory computer-readable media of claim 13, wherein determining the background crop includes determining the background scale based on the foreground scale and the reference scale.

16. The one or more non-transitory computer-readable media of claim 15, wherein determining the background scale includes determining the background scale as an interpolation between the foreground scale and the reference scale.

17. The one or more non-transitory computer-readable media of claim 12, wherein determining the background crop center includes determining the background crop center using a depth parameter, and wherein determining the background scale includes determining the background scale using the depth parameter.

18. The one or more non-transitory computer-readable media of claim 17, wherein the depth parameter has a value selected from a range bounded by a first endpoint at which the background crop center substantially coincides with the foreground crop center and a second endpoint at which the background crop center substantially coincides with a reference crop center.

19. The one or more non-transitory computer-readable media of claim 12, wherein the operations further comprise:
generating a reduced-resolution representation of the input frame; and
determining the foreground crop using the reduced-resolution representation.

20. A computer-implemented method comprising:
receiving an input frame;
determining a foreground crop for framing a subject, wherein the foreground crop is based on a foreground crop center and a foreground scale;
determining a background crop for framing a background layer, wherein the background crop is based on a background crop center and a background scale, and wherein at least one of the background crop center and the background scale is determined separate from the foreground crop;
applying, at a foreground crop-and-scale block of an image signal processor, a crop-and-scale transform to foreground content using the foreground crop to generate transformed foreground content;
applying, at a crop-and-upscale block of a background replacement block coupled to the image signal processor, a crop-and-upscale transform to background content using the background crop to generate transformed background content; and
blending the transformed foreground content and the transformed background content to output a composited frame.
